(19) United States
(12) Patent Application Publication
(10) Pub. No.: US 2022/0342058 A1
(43) Pub. Date: Oct. 27, 2022

(54) UNDERWATER ULTRASONIC DEVICES

(71) Applicant: Qisda Corporation, Taoyuan City (TW)

(72) Inventors: Fu-Sheng JIANG, Taoyuan City (TW); Yi-Hsiang CHAN, Taoyuan City (TW); Hsin-Chih LIU, Taoyuan City (TW)

(73) Assignee: Qisda Corporation, Taoyuan City (TW)

(21) Appl. No.: 17/693,968

(22) Filed: Mar. 14, 2022

(30) Foreign Application Priority Data
Apr. 23, 2021 (CN) 202110440780.1

(51) Int. Cl. G01S 7/521; G01S 15/89

(52) U.S. Cl. CPC G01S 7/521; G01S 15/89

(57) ABSTRACT

An underwater ultrasonic device is provided. The underwater ultrasonic device comprises: a setting area, wherein the setting area comprises a plurality of setting intervals in sequence, and a plurality of ultrasonic devices arranged in order along the setting area respectively corresponding to the setting intervals, wherein each of the ultrasonic devices has a signal opening angle, and the signal opening angle is greater than the arc angle of the arc interval corresponding to the ultrasonic device.

### TECHNICAL FIELD

The present invention relates to an underwater ultrasonic device, in particular, an underwater ultrasonic device having a curvature for underwater wide-angle measurement and capable of compensating for low energy areas on the left and right sides.

### RELATED ART

Traditional underwater ultrasonic transducers need to use multiple sets of ultrasonic transducers in arrangement and combination to achieve wide-angle imaging. However, the disadvantage is the low energy distribution on the two sides or the edges of each individual transducer. As such, the imaging system generates gaps between individual images.

### SUMMARY

Therefore, the present invention proposes an underwater ultrasonic device, which mainly uses a plurality of geometrically designed ultrasonic devices in arrangement and combination to overcome the problem of uneven energy distribution.

An embodiment of the present invention provides an underwater ultrasonic device. The underwater ultrasonic device includes: a setting area, wherein the setting area includes a plurality of arc intervals arranged in sequence, and a plurality of ultrasonic transducers respectively corresponding to the plurality of setting intervals, arranged and distributed along the setting area in sequence, wherein each of the ultrasonic transducers has a signal opening angle, and the signal opening angle is greater than the arc angle of the setting interval corresponding to the ultrasonic transducer.

Another embodiment of the present invention provides an underwater ultrasonic device. The underwater ultrasonic device includes: a setting area, wherein the setting area comprises a plurality of setting intervals, and a plurality of ultrasonic transducers, respectively corresponding to these setting intervals, arranged and distributed along the setting area in sequence, wherein each of the ultrasonic transducers has a signal interface width, and the signal interface width is greater than the width of the setting interval corresponding to the ultrasonic transducer.

Another embodiment of the present invention provides an underwater ultrasonic device. The underwater ultrasonic device includes: a first ultrasonic transducer having a first arc surface with a first curvature, wherein the first arc surface is used to receive a plurality of ultrasonic signals, and a second ultrasonic transducer having a second arc surface with a second curvature, wherein the second arc surface is used to receive a plurality of ultrasonic signals, wherein the endpoints of the first arc surface and the second arc surface are at least partially overlapped in a staggered manner.

In order to further understand the features and technical content of the present invention, please refer to the following detailed descriptions and drawings about the present invention. However, the drawings provided are only for reference and description, and are not used to limit the present invention.

### BRIEF DESCRIPTION OF THE DRAWINGS

FIG. 1 shows the diagram of a plurality of the ultrasonic transducers in connection with the body.

FIG. 2 shows the diagram of a plurality of ultrasonic transducers being separated from the body.

FIG. 3A shows a perspective view of the ultrasonic transducer.

FIG. 3B shows the top view of the ultrasonic transducer.

FIG. 3C shows the side view of the ultrasonic transducer.

FIG. 3D shows the overlapping receiving range of the ultrasonic transducers.

FIG. 4 shows the ultrasonic transducer arranged in a trapezoidal staggered arrangement.

FIG. 5 shows the ultrasonic transducer arranged in a T-shaped staggered arrangement.

FIG. 6A shows the diagram of a plurality of the ultrasonic transducer in connection with the body.

FIG. 6B shows the diagram of the ultrasonic transducers being separated from the body.

FIG. 7 shows the ultrasonic transducer arranged in a trapezoidal staggered arrangement.

FIG. 8 shows the ultrasonic transducer arranged in a T-shaped staggered arrangement.

### DETAILED DESCRIPTION

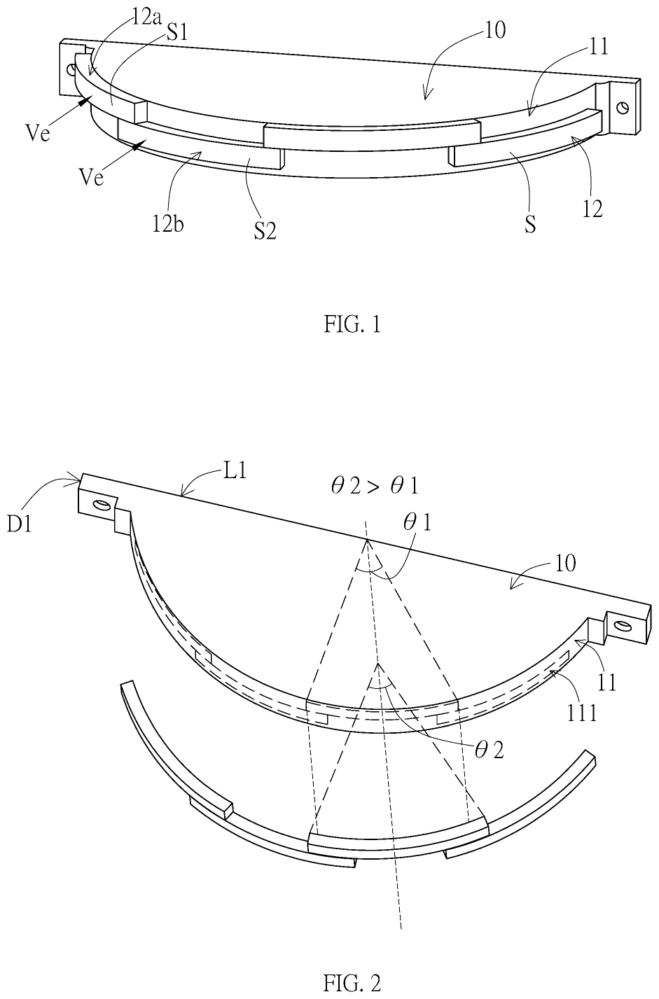

FIG. 1 and FIG. 2 show an underwater ultrasonic device according to an embodiment of the present invention. FIG. 1 shows the diagram of a plurality of ultrasonic transducers in connection with the body. FIG. 2 shows the diagram of a plurality of ultrasonic transducers separated from the body. As shown in FIG. 1 and FIG. 2, the underwater ultrasonic device includes a body 10, a setting area 11 arranged on the body 10, and a plurality of ultrasonic transducers 12. The setting area 11 includes a plurality of setting intervals 111 arranged in sequence. A plurality of ultrasonic transducers 12 are arranged and distributed in sequence along the setting area 11 and correspond to the intervals 111 respectively. Each ultrasonic transducer 12 has a signal angle θ2, which is greater than the arc angle θ₁ of the setting interval 111 corresponding to the ultrasonic transducer 12.

As shown in FIG. 2, the first ultrasonic transducer 12a of the plurality of ultrasonic transducers 12 has a first arc surface S1 with a first curvature, and the first arc surface S1 is used to receive a plurality of ultrasonic signals Ve; the second ultrasonic transducer 12b has a second arc surface S2 with a second curvature, and the second arc surface S2 is used to receive a plurality of ultrasonic signals Ve. Wherein, every two ultrasonic transducers are arranged in a staggered arrangement, and one end of one of every two ultrasonic transducers 12a overlaps with one end of the other one of every two ultrasonic transducers 12b. The endpoints of the first arc surface S1 and the second arc surface S2 are at least partially overlapped in a staggered manner. In other words, the first ultrasonic transducer 12a and the second ultrasonic transducer 12b are connected end to end corresponding to the first curvature.

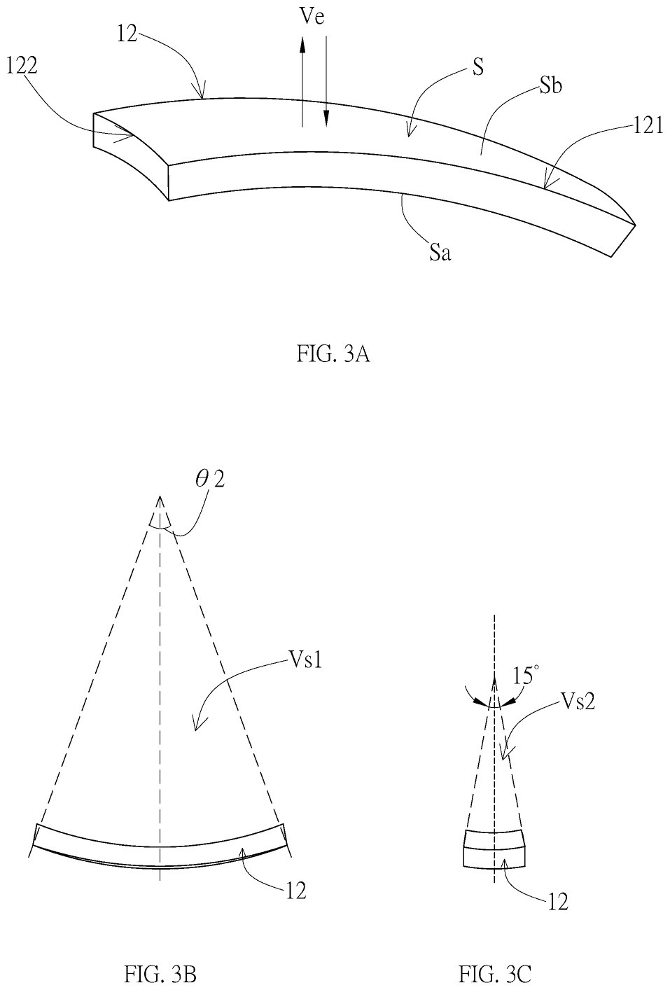

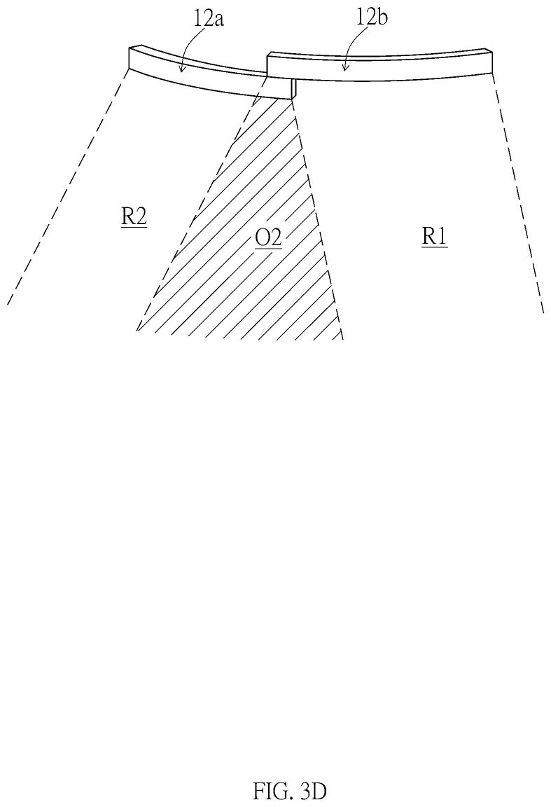

FIG. 3A shows a perspective view of the ultrasonic transducer; FIG. 3B shows a top view of the ultrasonic transducer; FIG. 3C shows a side view of the ultrasonic transducer; and FIG. 3D shows the overlapped receiving range of each pair of two ultrasonic transducers. As shown in FIG. 3A, a surface Sa opposite to the curved interface S is used to connect with the body 10, and the other surface Sb of the curved interface S is used to receive or transmit ultrasonic signal Ve. In this embodiment, the curved interface S can be regarded as a convex curved surface formed by respectively bending the long sides and the short sides of a long rectangle into curved sides. As shown in FIG. 3A, on the curved interface S, the first curve 121 and the second curve 122 intersect with each other, and the curvature of the first curve 121 and the curvature of the second curve 122 may not be equal. For example, the curvature of the first curve 121 may be greater than the curvature of the second curve 122. As shown in FIG. 3A, in this embodiment, the first curve 121 is the curve extending along the long arc side of the curved interface S, and the second curve 122 is the curve extending along the short arc side of the curved interface S. In addition, the body 10 has a long side L1 and a short side D1 that intersect with each other. The first curve 121 extends with a curvature along the long side L1, and the second curve 122 extends with a curvature along the short side D1. Secondly, the width of the ultrasonic transducer 12 may be less than or equal to the width of the short side D1 of the body 10. In this embodiment, the first curve 121 is the long axis of the ultrasonic transducer 12, and the second curve 122 is the short axis of the ultrasonic transducer. As such, the ultrasonic transducer uses the double-curvature design of the long and short axes of the first curve and the second curve, or, in another embodiment, a multi-curvature design, to expand the measurement of ultrasonic signals for wide-angle ranges.

As shown in FIG. 3B and FIG. 3C, the underwater ultrasonic device has different curvatures on different cross-sections and tangent lines. As shown in FIGS. 3B and 3A, the first curve 121 is the boundary line between the curved interface S and the first virtual cross-section Vs1, and the central angle corresponding to the first curve 121 is an acute angle, and the first curve 121 has a plurality of different curvatures on the curve. In this embodiment, the central angle corresponding to the first curve 121 is preferably between 115 degrees and 125 degrees, but it is not limited thereto. As shown in FIGS. 3C and 3A, the second curve 122 is the boundary line between the curved interface S and the second virtual cross-section Vs2, the central angle corresponding to the second curve 122 is an acute angle, and the second curve 12 has a plurality of different curvatures on the curve. In this embodiment, the optimal angle of the central angle corresponding to the second curve 122 is 15 degrees. It can be seen from FIGS. 2B and 2C that the first virtual cross-section Vs1 and the second virtual cross section Vs2 are perpendicular, and the average curvatures of the first curve 121 and the second curve 122 are different. In addition, each ultrasonic transducer 12 has a signal angle θ₂, which is greater than the arc angle θ₁ of the setting interval corresponding to the ultrasonic transducer.

In this embodiment, every two ultrasonic transducers (for example, ultrasonic transducers 12a and 12b) are arranged in a staggered arrangement, and one end of one of every two ultrasonic transducers 12a and one end of the other one of every two ultrasonic transducer 12b are overlapped in a staggered manner. FIG. 3D shows the overlapping receiving range of every two ultrasonic transducers. As shown in FIG. 3D, the first ultrasonic transducer 12a corresponds to a first receiving range R1, and the second ultrasonic transducer 12b corresponds to a second receiving range R2. The first receiving range R1 and the second receiving range R2 are at least partially overlapped. As shown in FIG. 3D, the first receiving range R1 and the second receiving range R2 have an overlapping area O2.

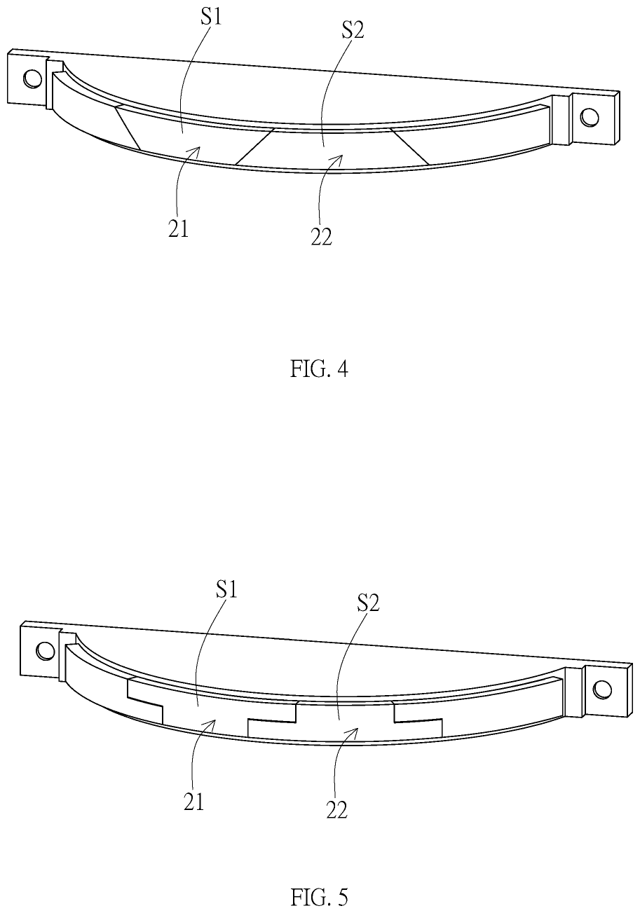

Although the ultrasonic transducer of the present invention described above is designed in an arc shape and in a staggered arrangement, it is not limited to this, and geometrical design (such as trapezoid) or text-shaped design (such as T-shaped) can also be made according to actual design requirements. FIG. 4 shows the ultrasonic transducers arranged in a trapezoidal staggered arrangement. As shown in FIG. 4, the first arc surface S1 of the first ultrasonic transducer 21 has a first curvature, and the first arc surface S1 is used to receive a plurality of ultrasonic signals Ve. The second ultrasonic transducer 22 has a second arc surface S2 with a second curvature, and the second arc surface S2 is used to receive a plurality of ultrasonic signals Ve, wherein, the endpoints of the first arc surface S1 and the second arc surface S2 are at least partially staggered. The first ultrasonic transducer 21 and the second ultrasonic transducer 22 are connected end to end corresponding to the first curvature. FIG. 5 shows ultrasonic transducers arranged in a T-shaped interlocking arrangement. As shown in FIG. 5, the first arc surface S1 of the first ultrasonic transducer 21 has a first curvature, and the first arc surface S1 is used to receive a plurality of ultrasonic signals Ve. The second ultrasonic transducer 22 has a second arc surface S2 with a second curvature, and the second arc surface S2 is used to receive a plurality of ultrasonic signals Ve, wherein, the endpoints of the first arc surface S1 and the second arc surface S2 are at least partially staggered. The first ultrasonic transducer 21 and the second ultrasonic transducer 22 are connected end to end corresponding to the first curvature. The functions of the ultrasonic transducers shown in FIG. 4 and FIG. 5 are the same as those of the ultrasonic transducers described in FIGS. 1-3, so it will not be repeated here.

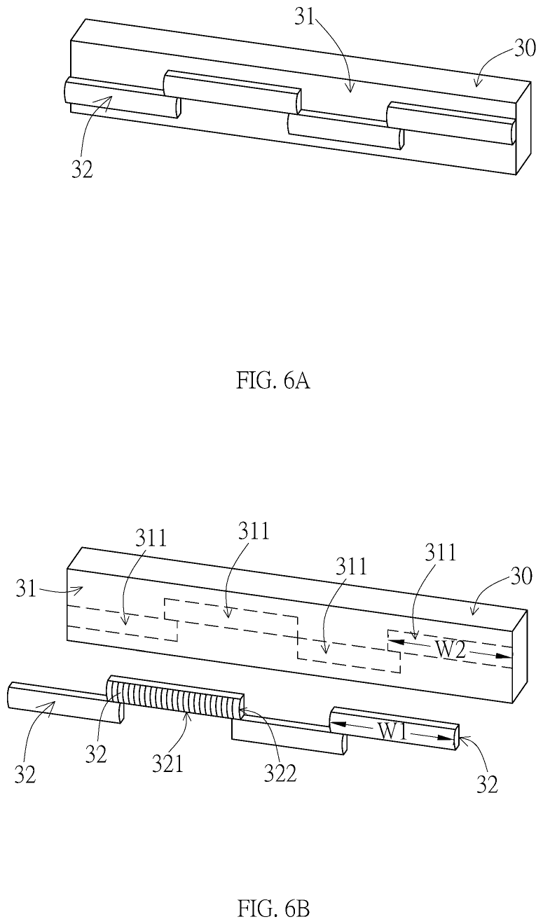

FIG. 6A and FIG. 6B show an underwater ultrasonic device according to another embodiment of the present invention. FIG. 6A shows a diagram of a plurality of ultrasonic transducers in connection with the body. FIG. 6B shows a diagram of the ultrasonic transducer separated from the body. As shown in FIGS. 6A and 6B, the underwater ultrasonic device includes a body 30, a setting area 31 provided on the body 30, and an ultrasonic transducer 32. The setting area 31 includes a plurality of setting intervals 311, and a plurality of ultrasonic transducers 32 are arranged and distributed along the setting area 31 and respectively correspond to the setting intervals 311, wherein, each ultrasonic transducer 32 has a signal interface width. The signal interface width W1 is greater than the width W2 of the setting interval 311 corresponding to the ultrasonic transducer 32. Every two ultrasonic transducers 32 are arranged in a staggered manner, and one end of one of every two ultrasonic transducers 32 and one end of the other one of every two ultrasonic transducer 32 are overlapped in a staggered manner.

In another embodiment, each ultrasonic transducer can further have an arc surface S. As shown in FIG. 6B, the curved interface S has a first boundary line 321 and a second boundary line 322. The first boundary line 321 intersects with the second boundary line 322, and at least one of the first boundary line 321 and the second boundary line 322 is a curve, and the curve can have a plurality of different curvatures. In this embodiment, the first boundary line 321 may be a straight line, and the second boundary line 322 may be a curved line. In this embodiment, the curve of the ultrasonic transducer adopts the design of a straight long axis (first boundary line 321) and a curved short axis (second boundary line 322), which can improve the sensitivity of the ultrasonic transducer.

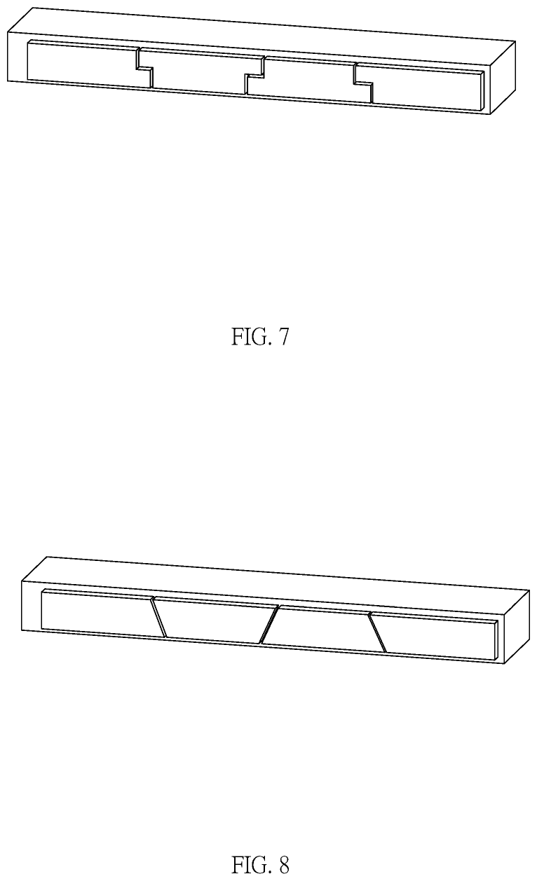

Although the ultrasonic transducer of the present invention described above is designed in an arc shape and in a staggered arrangement, it is not limited to this, and geometrical design (such as trapezoid) or text-shaped design (such as T-shaped) can also be used according to actual design requirements. FIG. 7 shows the ultrasonic transducers arranged in a trapezoidal staggered arrangement. FIG. 8 shows the ultrasonic transducers arranged in a T-shaped interlocking arrangement. The arrangement and function of the ultrasonic transducer shown in FIG. 7 and FIG. 8 are the same as those of the aforementioned ultrasonic transducers, so it will not be repeated here.

In the present invention, the arc measure of a plurality (e.g., 4) of ultrasonic transducers are combined to form a wide angle greater than 120 degrees, so as to avoid the low energy areas on the left and right sides. Furthermore, the present invention may splice together transducers each with an arc measure of 40 degrees and a uniform region of 30 degrees to form a combined measure of 120 degrees. In the present invention, a plurality of ultrasonic transducers with larger curvature are used to form an arced surface, and the middle uniform sections are combined to form a larger coverage range. The effective working area of the present invention is the linearly arranged short axes with arc characteristics. In addition to the functions of transmitting or receiving, the ultrasonic transducer of the present invention also has ultra-long linear probe splicing to compensate for the low energy areas on both sides of the ultrasonic transducer.

The content disclosed above is only the preferred and feasible embodiments of the present invention, which does not limit the scope of the patent application of the present invention. Therefore, all equivalent technical changes made using the description and schematic content of the present invention fall into the patent application scope of the present invention.

What is claimed is:

1. An underwater ultrasonic device, comprising:
a setting area, wherein the setting area comprises a plurality of setting intervals in sequence arrangement; and
a plurality of ultrasonic transducers, respectively corresponding to the plurality of setting intervals, arranged and distributed along the setting area in sequence;
wherein each of the ultrasonic transducers has a signal opening angle, and the signal opening angle is greater than an arc angle of the setting interval corresponding to the ultrasonic transducer.

2. The underwater ultrasonic device according to claim 1, wherein the underwater ultrasonic device has a long side and a short side intersected the long side, and each ultrasonic transducer has a first curve and a second curve, the first curve extends along the long side, and the second curve extends along the short side, wherein the first curve intersects the second curve.

3. The underwater ultrasonic device according to claim 2, wherein the first curve or the second curve has a plurality of different curvatures, wherein average curvatures of the first curve and the second curve are different.

4. The underwater ultrasonic device according to claim 2, wherein the ultrasonic transducer further has an arc surface, and the first curve is a common boundary between the arc surface and a first virtual cross-section, and the second curve is a common boundary between the arc surface and a second virtual cross-section, wherein the first virtual cross-section is perpendicular to the second virtual cross-section.

5. The underwater ultrasonic device according to claim 1, wherein every two the ultrasonic transducers are arranged in a staggered arrangement, and one end of one of every two the ultrasonic transducers overlapped up and down with one end of the other one of every two the ultrasonic transducers.

6. An underwater ultrasonic device, comprising:
a setting area, wherein the setting area comprises a plurality of setting intervals; and
a plurality of ultrasonic transducers, respectively correspond to the plurality of setting intervals, arranged and distributed along the setting area in sequence;
wherein each of the ultrasonic transducers has a signal interface width, the signal interface width is greater than the width of the setting intervals corresponding to the ultrasonic transducer.

7. The underwater ultrasonic device according to claim 1, wherein every two the ultrasonic transducers are arranged in a staggered arrangement, and one end of one of every two the ultrasonic transducer overlapped up and down with one end of the other one of every two the ultrasonic transducer.

8. An underwater ultrasonic device, comprising:
a first ultrasonic transducer having a first arc surface with a first curvature, wherein the first arc surface is used to receive a plurality of ultrasonic signals; and
a second ultrasonic transducer having a second arc surface with a second curvature, wherein the second arc surface is used to receive a plurality of ultrasonic signals, wherein the endpoints of the first arc surface and the second arc surface are at least partially staggered setting.

9. The underwater ultrasonic device according to claim 8, wherein the first ultrasonic transducer and the second ultrasonic transducer are connected end to end and correspond to the first curvature.

10. The underwater ultrasonic device according to claim 9, wherein the first ultrasonic transducer corresponds to a first receiving range, the second ultrasonic transducer corresponds to a second receiving range, the first receiving range and the second receiving range at least partially overlapped.
